(19) United States
(12) Patent Application Publication
(10) Pub. No.: US 2013/0190901 A1
(43) Pub. Date: Jul. 25, 2013

(54) METHOD AND SYSTEM FOR SAFELY MANAGING GAS STATION

(71) Applicants: Jae Wook Ko, Seoul (KR); Heon Suk Lee, Seoul (KR); Jae Min Seo, Seoul (KR); Kee Bong Yoon, Yongin-si Gyeonggi-do (KR)

(72) Inventors: Jae Wook Ko, Seoul (KR); Heon Suk Lee, Seoul (KR); Jae Min Seo, Seoul (KR); Kee Bong Yoon, Yongin-si Gyeonggi-do (KR)

(21) Appl. No.: 13/878,254

(22) PCT Filed: Oct. 10, 2011
(86) PCT No.: PCT/KR11/07479

§ 371 Date: Apr. 8, 2013

(30) Foreign Application Priority Data
Oct. 8, 2010 (KR) 10-2010-0098410

(51) Int. Cl. G05B 19/048

(52) U.S. Cl. CPC G05B 19/048
USPC 700/80

(57) ABSTRACT

A gas station safety management system of the present invention includes a sensor network having sensors which are provided at gas station equipment, a monitoring module which receives sensing signals from the sensors, maps the gauge values of the sensing signals on a map in which the gas station equipment is described, and generates a warning signal when the sensing signals exceed a predetermined reference range, and a user interface for displaying the map, the mapped gauge values, and the warning signal on a screen.

### TECHNICAL FIELD

The present invention relates to a safety management, and more particularly, to a system for safely managing a gas station.

### BACKGROUND ART

In general, gas stations are facilities that store LNG or LPG to supply the stored

LNG or LPG into vehicles, thereby charging public transportations such as CNG or LPG buses. Public transport vehicles pass through gas stations in constant succession, and also, the gas stations should be located at big cities on characteristics of public transport services. Thus, the gas stations may be exposed to an explosion or leak risk of gas. As a result, the gas stations may be facilities that are expected to cause extensive damage in accident because the gas stations are located at big cities.

Typical gas station control equipment collects information detected by a variety of sensors disposed at a plurality of places within a gas station to inform the collected information to a manager. However, which step should come next when abnormal sensors occur may have no choice but to depend on experience snap judgment of the manager.

### DISCLOSURE OF THE INVENTION

### Technical Problem

The present invention provides a gas station safety management system which monitors gas station equipment in real-time and evaluates riskiness of the gas station equipment to draw response scenario, thereby primarily preventing disasters from occurring and secondarily minimizing damages.

### Technical Solution

A gas station safety management system according to an aspect of the present invention includes:

a sensor network having sensors which are provided at gas station equipment;

a monitoring module which receives sensing signals from the sensors, maps the gauge values of the sensing signals on a map in which the gas station equipment is described, and generates a warning signal when the sensing signals exceed a predetermined reference range; and

a user interface for displaying the map, the mapped gauge values, and the warning signal on a screen.

In an embodiment, the map may include one of a process flow map and a design drawing map.

In an embodiment, the gas station safety management system may further include

an emergency response scenario module storing an accident scenario that is capable of occurring in the gas station equipment and a response scenario that defines actions of a manager and worker or an operation of emergency equipment to response to the accident scenario.

In an embodiment, the gas station safety management system may further include

a quantitative risk assessment (QRA) module digitizing a long- or short-range change of the sensing signals to renew accident occurrence probability at each position of the gas station equipment, thereby evaluating social riskiness of the gas station equipment and personal riskiness at the each position of the gas station equipment on the basis of the renewed accident occurrence probability.

In an embodiment, the QRA module

determines a present situation as a dangerous situation when the social riskiness evaluated on the basis of the accident occurrence probability exceeds an allowable limitation.

### Advantageous Effects

In a case of a conventional monitoring system, when equipment is abnormal during the operation, the equipment is stopped in operation. However, the gas station safety management system according to the present invention may determine abnormal occurrence possibility through the QRA module in advance. Thus, when the abnormal occurrence possibility increases, repair plans may be reflected so that the emergency blockage may be prevented from occurring during the operation.

Also, the gas station safety management system according to the present invention may analyze the riskiness of respective equipment through the QRA module to establish the repair plan on the basis of the riskiness. For example, the equipment having relatively high riskiness may be repaired first.

### BRIEF DESCRIPTION OF THE DRAWINGS

FIG. 1 is a conceptive view illustrating a safety management system of a gas station according to an embodiment.

FIG. 2 is a view illustrating an example of a process flow-based monitoring screen provided on a monitoring module of the safety management system of the gas station according to an embodiment.

FIG. 3 is a view illustrating an example of a drawing-based monitoring screen provided on the monitoring module of the safety management system of the gas station according to an embodiment.

### MODE FOR CARRYING OUT THE INVENTION

Although specific structural or functional descriptions with respect to embodiments disclosed in this specification are merely exemplified for purpose of the present invention, various changes in form may be made to limit the meaning of the embodiments.

Exemplary embodiments of the present invention will be described below in more detail with reference to the accompanying drawings. Like reference numerals refer to like elements throughout, and also, their detailed descriptions will be omitted.

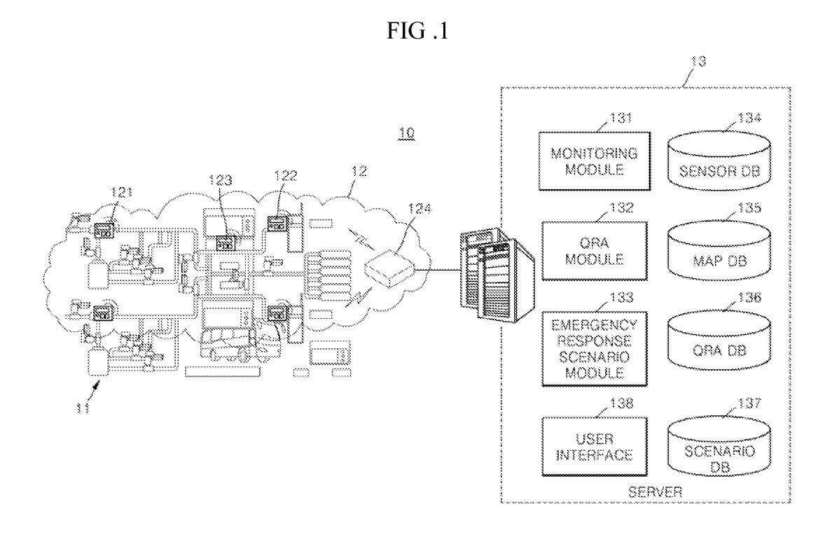

FIG. 1 is a conceptive view illustrating a safety management system of a gas station according to an embodiment.

Referring to FIG. 1, a gas station safety management system includes a sensor network 12 and a server 13 which are installed at gas station equipment.

The gas station equipment 11 supplies natural gas (NG) or petroleum gas (PG) which is liquefied at a high-pressure low-temperature to store the LNG or LPG for a long time. Also, since the gas station equipment 11 is constituted by various tanks, compressors, coolers, valves, and pipes to inject the LNG or LPG into vehicles, the gas station equipment 11 should be maintained at a pressure, temperature, and vibration within a fixed standard that is defined for safety.

For this, adequate manometer, thermometer, and vibrometer sensors 121, 122, and 123 are installed in the valves, compressors, and coolers within the gas station equipment 11, respectively. The sensors 121, 122, and 123 transmits detected signals into the server 13 via a gateway 124 through a wired method such as controller area network (CAN) or a wireless communication method such as CDMA, Zigbee, or LoWPAN.

The server 13 includes a monitoring module 131, a QRA module 132, an emergency response scenario module 133, a sensor DB 134, a map DB 135, a QRA DB 136, a scenario DB 137, and a user interface 138.

The monitoring module 131 receives sensing signals that are collected in a sensor network 12 and transmitted via the gateway 124. The monitoring module 131 stores the sensor DB 134 for each of the sensors corresponding to the received sensing signals.

A process flow map of storage, cooling, compression, and distribution of the LPG or LNG in the gas station equipment 11 is stored in the map DB 135. Actual installation positions of the sensors 121, 122, and 123 in the gas station equipment 11 and positions of the sensor gauges displayed on the process flow map match one-to-one or several-for-one so that the manager easily manages the sensors 121, 122, and 123.

The monitoring module 131 may input gauge values, i.e., pressure, temperature, and vibration values obtained from the sensing signals that are received from the sensor network 12 into the sensor gauges displayed on the process flow map that is read from the map DB 135 and graphically display the instrument values through the user interface 138 so that the manager sees the instrument values.

Also, a detailed design drawing map of the gas station equipment 11 is stored in the map DB 135. Similarly, the actual installation positions of the sensors 121, 122, and 123 in the gas station equipment 11 may be one-to-one match positions of the sensor gauges displayed on the design drawing map.

The monitoring module 131 may input pressure, temperature, and vibration values obtained from the sensing signals that are received from the sensor network 12 into the sensor gauges displayed on the design drawing map that is read from the map DB 135 and graphically display the instrument values through the user interface 138 so that the manager sees the instrument values.

Also, the monitoring module 131 analyzes the sensing signals to classify the sensing signals as an abnormal state when the pressure, temperature, and vibration get out of a normal range, for example, when a state above a predetermined range continues for longer than a predetermined time. In addition, when the abnormal state occurs more than a predetermined number of times, the monitoring module 131 may generate a warning signal to the manager through the user interface 138.

Generally, a quantative risk assessment (QRA) may analyze accidents expected during a life cycle of the equipment through many different ways when the equipment is constructed. Also, the QRA may quantitatively analyze risks through the extent and frequency of damage and come up with a set of regulations with respect to risk elements so that the riskiness remains within an allowable regulation or standard. For this, the QRA calculates the frequency of accidents on the basis of data constructed from management experience of various equipment so far, i.e., generic failure data.

The generic failure data may be data accumulated for application of reliability analysis of similar instrumentations under similar circumstances and also may being published from many institutions. Generally, the generic failure data may be effectively utilized for measuring the reliability of plants, facility systems, and equipment, quantifying risks, optimizing maintenance management, devising a maintenance management plan according to risks, improving designs of new devices, and optimizing costs due to a life cycle. Representative generic failure data may include an offshore reliability data handbook (OREDA), a european industry reliability data bank (EIREDA), and nonelectronic parts reliability data (NPRD-91). Here, various data is being published for each field. For example, process equipment reliability database (PERD) of center for chemical process safety (CCPS) is being widely used as generic failure data for petrochemical devices. Also, data published by institute electrical and electronics engineers (IEEE) is being widely used as generic failure data for electrical and electronic fields.

Riskiness of predictable accidents in the equipment may be numerically estimated by classifying the riskiness into personal riskiness and social riskiness.

The social riskiness may be expressed as a relationship between the sum F of probability of accidents that may occur in any specific dangerous facilities and human damage N due to the accidents on the basis of the averagely allowable riskiness in a population group. Also, the social riskiness may represent social acceptable limitation of the personal riskiness.

Generally, since the QRA is a method for changing a design such as safety design reinforcement and processing process improvement of dangerous materials when riskiness within life cycles of the dangerous facilities is analyzed to determines that the riskiness exceeds the acceptable limitation, the QRA may be used once during the construction of the dangerous facilities.

On the other hand, the QRA module 132 digitizes a long- or short-range change of the sensing signals collected in the sensor network 12, an internal change applied to the gas station equipment 11, e.g., effects due to regular or irregular repair, success, failure, or delay of repair, replacement of main devices and the like, and an external environment change applied to the gas station equipment 11, e.g., effects due to heat wave, hard freeze, flood, gust, earthquake, and the like to reflect and renew accident occurrence probability, thereby storing the renewed accident occurrence probability into the QRA DB 136.

Furthermore, the QRA module 132 divides an accident riskiness index at various possible places into personal riskiness and social riskiness in real-time on the basis of the accident occurrence probability that is continuously renewed to evaluate the personal riskiness and social riskiness.

If the QRA module determines that the social riskiness exceeds allowable limitation with respect to the gas station equipment 11, for example, it is evaluated that the social riskiness is greater than about 10̂-7 in aspect of human accident, the QRA module 132 may determine this situation as a dangerous situation. Furthermore, in this case, the QRA module 132 decides a danger point contributed most toward the excess of the allowable limitation of the social riskiness and then applies preliminary accident occurrence scenario at the danger point to estimate personal riskiness according to the preliminary accident occurrence scenario, thereby displaying the personal riskiness in a form of a risk contour indicated on geographic information including the equipment through the user interface 138 so that the manager see the personal riskiness displayed in the contour form.

In ordinary days, the QRA module 132 may provide the personal riskiness to the manager in the contour form in a case where a specific scenario is given to a specific position when instructed by the manager.

The emergency response scenario module 133 stores a predetermined response scenario that defines an action of the manager or an operation of emergency equipment with respect to credible accidents, an evacuation scenario, a rescue scenario, and a restoration scenario in the scenario DB 137 to manages the scenarios.

Also, when an accident occurs, the emergency response scenario module 133 reflects the personal riskiness estimated lately by the QRA module 132 on the response scenario, evacuation scenario, rescue scenario, and restoration scenario which are stored in the scenario DB 137 to display an actual scenario so that the manager sees the actual scenario, thereby operating the emergency equipment or safety equipment according to the actual scenario. For example, when the personal riskiness increases in the QRA module 132, the emergency response scenario module 133 displays the increased personal riskiness to induce the user so that the user recognizes this problem. The user confirms a range and reduction plan of the problem, and then reflects the reduction plan on the emergency response scenario.

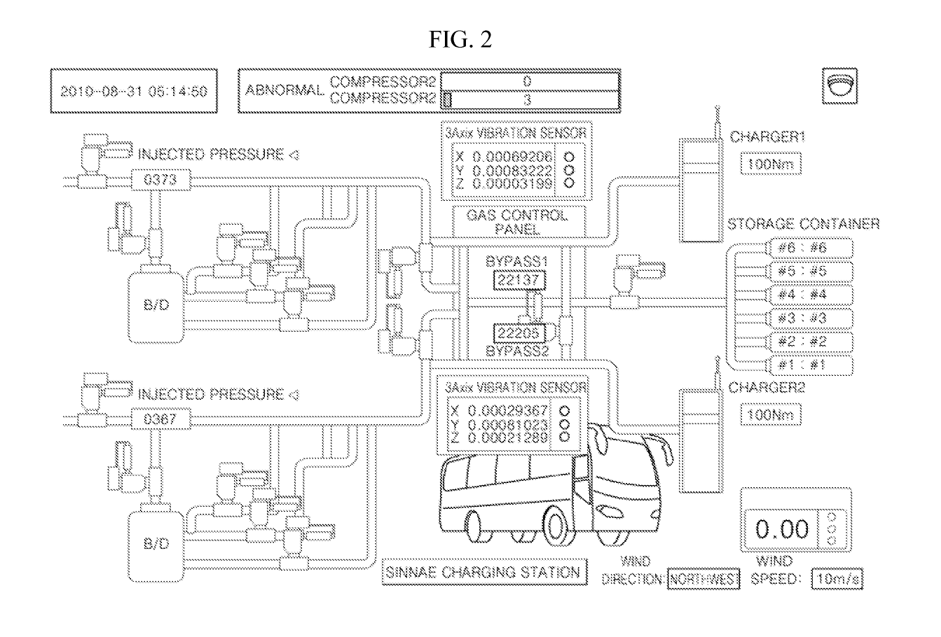

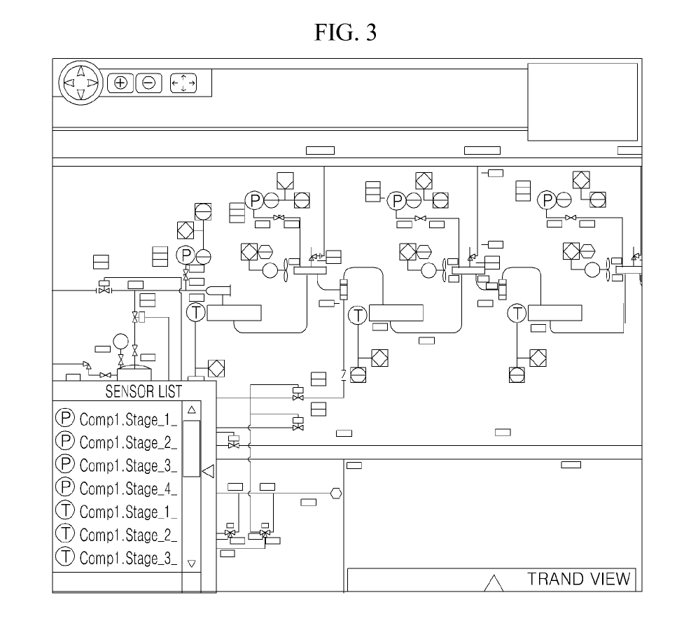

FIGS. 2 and 3 are views illustrating a process flow-based monitoring screen and drawing-based monitoring screen which are provided on a monitoring module of the safety management system of the gas station according to an embodiment.

Referring to FIG. 2, the monitoring module 131 of the safety management system 10 of the gas station may map main points on the process flow map stored in the map DB 135 with the sensors 121, 122, and 123 actually installed at various positions of the gas station equipment 11 to respectively display values of the sensing signals on points of the process flow map.

Referring to FIG. 3, the monitoring module 131 of the safety management system 10 of the gas station may map main points on the design drawing map stored in the map DB 135 with the sensors 121, 122, and 123 actually installed at various positions of the gas station equipment 11 to respectively display values of the sensing signals on points of the design drawing map.

As described above, although the present invention is described by the limited embodiment and drawings, the present invention is not limited to the foregoing embodiment. Further, it will be understood by those of ordinary skill in the art that various changes in form and details may be made therein. Thus, the spirit and scope of the present invention should be grasped by only the following claims, and its equal or equivalent modifications belong to the scope of the present invention.

The devices according to the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), optical disks, magnetic tapes, floppy disks, hard disks, and nonvolatile memories, and carrier waves (such as data transmission through the Internet). The computer readable recording medium can also be distributed over network coupled computer systems so that the computer readable code is stored and executed in a distributed fashion.

Pursuant to 37 CFR §1.121(c), this listing of the claims, including the text of the claims, will serve to replace all prior versions of the claims, in the application.

1. A gas station safety management system, comprising:
a sensor network installed in gas station equipment, the sensor network comprising sensors for measuring a pressure, temperature, and vibration of the gas station equipment;
a monitoring module receiving sensing signals from the sensors and mapping pressure, temperature, and vibration values of the gas station equipment on a map expressing the gas station equipment to generate a warning signal for informing an abnormal state of the gas station equipment by using whether the sensing signals exceed a predetermined reference range, or a time and number which exceed the predetermined reference range;
a user interface for displaying the map, the mapped values, and the warning signal on a screen; and
a quantitative risk assessment (QRA) module digitizing a long- or short-range change of the sensing signals, an internal environment change comprising a change of a maintained state, a change of a repaired state, and a change of replacement of devices, and an external environment change applied to the gas station equipment to renew accident occurrence probability at each position of the gas station equipment, thereby evaluating social riskiness of the gas station equipment and personal riskiness at the each position of the gas station equipment on the basis of the renewed accident occurrence probability,
wherein the QRA module determines a present situation as a dangerous situation when the social riskiness evaluated on the basis of the accident occurrence probability exceeds an allowable limitation.

2. The gas station safety management system of claim 1, wherein the map comprises one of a process flow map and a design drawing map.

3. The gas station safety management system of claim 1, further comprising an emergency response scenario module storing an accident scenario that is capable of occurring in the gas station equipment and a response scenario that defines actions of a manager and a worker or an operation of emergency equipment in response to the accident scenario.
